(19) United States
(12) Patent Application Publication
(10) Pub. No.: US 2008/0120147 A1
(43) Pub. Date: May 22, 2008

(54) Methods and apparatus for electronically storing travel agents coupons

(76) Inventor: Rodger Burrows, Plantation, FL (US)

Correspondence Address: Richard M. Saccocio, P.A., 780 W. Tropical way, Plantation, FL, 33317, US

(21) Appl. No.: 11/904,962

(22) Filed: Sep. 28, 2007

Related U.S. Application Data
(63) Continuation-in-part of application No. 09/910,654, filed on Jul. 20, 2001.

(51) Int. Cl. G06Q 10/00; G06Q 30/00

(52) U.S. Cl. 705/5; 705/14

(57) ABSTRACT

Methods and apparatus to electronically save agent coupon data while printing an airline ticket in conjunction with an airlines travel agency reservation system include the steps of inputting passenger flight information into an airline reservation system that outputs the information in ASCII form, identifying the information corresponding to an airline ticket, identifying the information corresponding to all other information including agent coupon information, allowing the ticket information to be printed transmitting said all other information to electronic apparatus having computing and storage capabilities, capturing all of the information associated with an the agent coupon and storing the same in a raw data capture file, extracting the agent coupon data free of all other instructions and extraneous information from the captured raw data file and applying an electronic identifier to the same, and using the electronic identifier, storing the agent coupon data in an agent coupon folder.

### CROSS REFERENCE TO RELATED APPLICATIONS

This application is a Continuation In Part, under 37 CFR 1.53(b), of U.S. patent application Ser. No. 09/910,654 filed on Jul. 20, 2001, entitled Methods and Apparatus for Electronically Storing Travel Agent Coupons.

### BACKGROUND OF THE INVENTION

1. Field of the Invention

This invention relates in general to the field of electronic storage of data and in particular to methods and apparatus for electronically identifying and capturing reservation or coupon data from the stream of information associated with airline tickets procured through a travel agent and subsequently storing the particular data on an individual item basis.

2. Description of the Prior Art

Most, if not all airline ticket service organizations or travel agents provide the service of reserving and issuing airline tickets to travelers. A special computer system commonly known as the reservation system that is accessible to each travel agent is used exclusively for this purpose

To issue a ticket a travel agent must first create a reservation consisting of, in general, the sundry details of the reservation. Once done a ticketing or go command, is entered into the reservation system. The reservation system then transmits the reservation information from a mainframe computer where a specialized program arranges the information into an information stream that comprises all of the information associated with the various “coupons” and airline ticket The information stream is then sent to a printer located at the travel agency which prints the ticket and all associated “coupons” one of which is known as the agent coupon. This is an automated process that neither requires nor generally permits user intervention.

The stream of information that is readable only by the reservation system consists of ASCII control characters and alphanumeric data. It is to be noted that even at this point, the stream of information is not electronically separated into each of the various coupons or even the airline ticket, everything is intermingled. Special software programmed into the reservation system sends the information to the printer with instructions detailing which information is to be printed as what and as where on blank coupon or airline ticket stock. Thus, even as printed, the passenger transaction does not comprise data as known and used in the present day field of electronics. It cannot be extracted, saved, or transmitted using the reservation system but rather merely exists as an item of information as it appears on the printed documents.

For example the printer prints the coupons which can include the flight coupon(s), passenger receipts, charge coupons, auditor coupons and agent coupons. This is an automated process that does not permit a user to intervene, obtain, capture or change the separate information printed for each coupon. In other words, within the reservation system, the information for each coupon does not exist as a separate set of data but rather as information and therefore cannot normally be extracted or captured from the reservation system. But of course, the subject information exists within the reservation and also at the cable connection to the printer.

Airline agencies known as the Airlines Report Corporation (ARC), International Air Transport Association (IATA) and various government tax authorities require travel agencies to retain physical copies of “agent coupons” for a minimum of two years from the date of issuance of an airline ticket. The main reason being that once the transaction completed and the ticket used, no complete electronic record exists of the transaction. The agent coupon comprises of the only complete record of the transaction. In general, an agent coupon contains data associated with an issued airline, ticket such as the name and address of the passenger, travel dates, the name of the airline, departure and arrival locations and time, fares charged for the ticket, and other like information. The record reason for retention of the hard copies of the coupons is that, as noted above, complete electronic records do not exist subsequent to the transaction. The practical reasons for the requirement to have airline ticket agencies retain hard copies of the agent coupons, since no complete electronic records exist, are for tax purposes and to have a sufficient record of the ticket transaction should a dispute arise, for example, regarding a refund, when a ticket exchange is necessary or any other like reason. The tax reason is an obvious requirement to assure that all of the proper taxes have been collected and later reported. The agent coupons are not, therefore, generally accessed by the airline ticket agencies on a daily basis but rather only a sporadic or an as necessary basis to supply the complete transaction information to ARC, a particular airline, or a government agency. Thus, for sundry reasons, it is necessary for the airline ticket agencies to provide for storage of the hard copies of the coupons inasmuch as the travel agents are the original source of the transaction. The agent coupons also protect the travel agencies from any allegations of wrongdoing. Thus, in the travel industry, it is common for the agencies to keep the agent coupons for a period of time between two and ten years. Necessarily then, the travel agents must provide for long-term storage of the physical coupons.

Because of the nature of the required and self-imposed storage of the agent coupons in conjunction with the “access as necessary” of the coupons, the physical storage of the coupons pose a number of unique and bothersome problems. Typically, the agent coupons are stored in specially sized containers or boxes in the order that they were printed. Still and obviously, a storage facility or storage space is required. If the storage is within the offices of the service agency the agent coupon records consume valuable office space. If the storage is within an outside storage facility, extra costs are involved which is accompanied by the nuisance of travel to and from the outside storage facility.

Should it be necessary to access a particular agent coupon, the time consuming and general inconvenience of having to sort through a plethora of stacked boxes, retrieve the coupon in question, restack the boxes and then go through the same procedure to return the coupon to its original storage location is readily envisioned. It is axiomatic that the larger the travel agency, the more these problems are exacerbated.

What is needed are apparatus and methods that allow for the ease of maintaining the electronic storage of the record of a travel reservation instead of the prior art hard copy storage requirement, including but not necessarily limited to agent coupons, by a travel agency, allow for ease of retrieval of the record, eliminate the need for a separate storage space, provide for secure storage, and be cost effective. The present invention accomplishes these objectives.

### SUMMARY OF THE INVENTION

The above-stated objects as well as other objects which, although not specifically stated, but are intended to be included within the scope the present invention, are accomplished by the present invention and will become apparent from the hereinafter set forth Detailed Description of the Invention, Drawings, and Claims appended herewith. The present invention accomplishes these objectives by providing methods and apparatus for electronic storage of agent coupons in a most effective manner.

In order to better understand the advantages of the present invention a brief understanding of the details of the prior art system is helpful. For an airline ticket to be issued the agent creates a reservation in the reservation system. Once the reservation containing all the necessary information is input into the reservation system, a ticket issue or a “GO” command is executed. From that point on the reservation system automatically performs the tasks necessary to send the information from a central mainframe computer to the printer server located in the travel agency. The printer server is directly connected to a ticket printer which then automatically prints the ticket and all associated coupons. The reservation system also includes an accounting function that allows a bookkeeper to track the financial aspects of each reservation transaction. And, as noted above, the reservation system and its functional arrangement is an integral system that is specially designed to fulfill its specific purposes and is generally not able to be modified by the travel agency. However, through the unique methods and apparatus of the present invention, the prior art reservation system is arranged to perform all of its original functions with the exception of eliminating the need to print the agent coupons.

In the various embodiments of the present invention, electronic data storage apparatus is electronically connected to an airline ticket reservation arrangement in a unique manner that allows the reservation system to simultaneously print an airline ticket while electronically storing the agent coupons as data. In one embodiment, a specialized adapter is used to allow the creation of or capturing of the coupon data and then electronic storage of the coupon data while simultaneously allowing the printing of the ticket. The adapter can be arranged to work with the normal printing functions or the accounting functions of the reservation system. In another embodiment a batch file arrangement is created that provides, captures or creates the data that allows the storage of the coupon data.

The same method and apparatus can be made to send all or any of the other coupons or data to the electronic storage apparatus. Once within the electronic storage apparatus, a programmed computer provides for coupon data storage and subsequent retrieval. Of course, the electronic storage apparatus is specially programmed to accomplish the respective tasks. Within the electronic storage apparatus, the coupon data, and or any other reservation system data, is given an identifier. Subsequently, at the option of the user, any particular coupon data or other record of the transaction can be retrieved by reference to the identifier. The object being to separate the coupon data from the ticket data and allow the coupon data to be separately processed including storage, display, and if desired, printing of the same.

The reservation system, the storage apparatus, the retrieval apparatus, and the printer can each be located at the same site, or each can be located at a different site, or each can be located at any combination thereof. Any site can be activated by an intranet network connection or by an internet network connection using an appropriate internet browser.

In accordance with the above, there has been summarized the more important features of the present invention in order that the detailed description of the invention as it appears in the below detailed description of the same, may be better understood.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a pictorial illustration of a typical prior art travel agency reservation system.

FIG. 2 is a pictorial representation of a typical prior art agent coupon.

FIG. 3 is a simplified schematic block flow diagram of one embodiment of the present invention illustrating the apparatus and methods as contemplated by the present invention;

FIG. 4 is a detailed block flow diagram illustrating the use of the reservation system printing functions and or the accounting functions to capture, or create the coupon data to allow electronic storage of the data while printing of the airline ticket.

FIG. 5 is a schematic block flow diagram of the basic apparatus of FIG. 1 as applied to a computer network arrangement.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functioning details disclosed herein are not to be interpreted as limiting, but merely as a basis for the claims and as a representative basis for teaching one skilled in the art to variously employ the present invention in virtually any appropriately detailed structure. Additionally, the words and phrases used herein are intended to better enable a person to understand the invention and therefore, such words and phrases are not to be interpreted as limiting the invention.

Reference is now made to the drawings, wherein like the characteristics and features of the present invention shown in the various figures are designated by the same reference numerals.

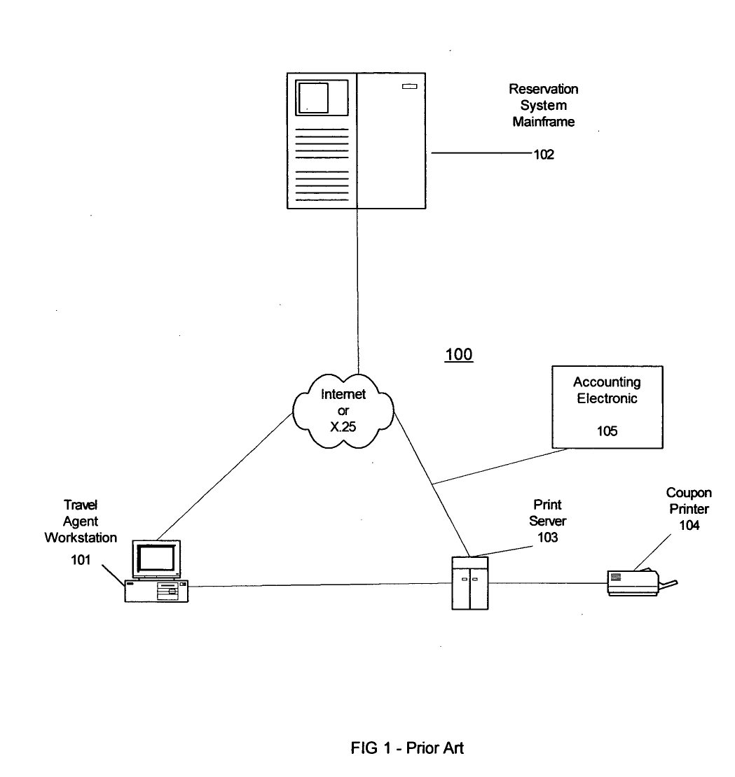

FIG. 1 is a simplified representation of a typical prior art reservation system. A typical airline ticket reservation system 100 comprises an agent work station located at the travel agency that basically comprises a computer, a display, a keyboard, mouse, etc. The work station 101 is connected to a mainframe computer 102 that is most likely located at a remote location in order to serve a number of travel agencies. A print server 103 is connected to the mainframe computer 102 and to a local printer 104. Accounting electronics 105 are also located at the agency and incorporated in the reservation system 100 so that financial tracking of the airline transaction can be accomplished. The reservation system 100 thusly comprises the electronic apparatus that an agency normally employs to generate a paper record of the sundry items making up the ticketing transaction. It is most important to understand that the prior art system does not have the capability to either generate or store the data associated with each paper item printed by the prior art system. This is because the information, for example, for the agent coupon is not recognized as pure data within the system 100 but rather as raw data having other information and instructions associated with it. Furthermore, one cannot capture the agent coupon information as it arrives at the printer and shunt it to a storage medium because it is raw data and not free of associated information and instructions. The only capability of the printer 104 is to receive particular information of the agent coupon and assign it to a particular location on a blank paper agent coupon that is fed to the printer. Thus, if a blank piece of paper were fed to the printer, the printer would print the data comprising for example, the passenger's name at a particular location on the blank piece of paper corresponding to the same location on a blank agent coupon. But, the printer 104 would not know that it is the passenger's name and could not therefore store the passenger's name in a data file under the designation of a passenger's name. Accordingly, the printer would print the passenger's name but it would not be data that could subsequently be used in a data file. The same is true for the other pieces of information printed by printer 104. While the accounting or financial arm 105 of the reservation system 100 does deal in financial data, the data associated with the financial arm is not a complete record of the entire transaction and therefore is not capable of effectuating storage of agent coupon data.

The electronic connections of the system 100 can be a serial connection, a modem connection, or an intranet/internet network connection. When instructed by the system 100, a travel agent inputs the various and well known reservation system information that is needed to carry out all of the prior art functions of the reservation system 100. After all of the required information is input as instructed, the travel agent issues a “go” or equivalent command resulting in the system automatically printing the usual coupons and the airline ticket and sending certain accounting information to the accounting arm 105 of the system. However, as explained above, neither the printing arm 104 nor the accounting arm 105 of the system 100 is capable of generating complete data that could be used to eliminate the paper copies of the coupons, allow the printing of the airline ticket and store the coupon data for future retrieval. On the other hand, the inventive methods and apparatus can create a pure data file of the agent coupon either from the printing arm 104, or the accounting arm 105, or even the reservation system 100 itself.

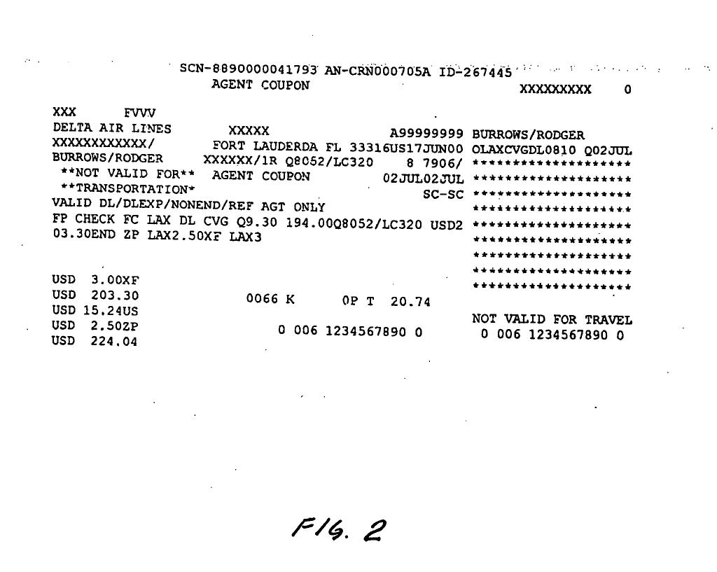

FIG. 2 pictorially illustrates a copy of a prior art agent coupon albeit with fictitious information thereon. As can be seen, the coupon contains information relating to a particular passenger as well as other typical ticket and scheduling information. Noted also is that the ticket costs and charges are contained on the coupon. Accordingly, it is understandable why the agent coupon has retained its importance over the years. However, in this modern age, paper copies are obsolete and are gradually being replaced by more convenient electronic records. But, as noted above, it is not the simple matter of creating a program installing it on a computer, connecting the computer to the reservation system 11 and converting the information on the agent coupon, or any other coupon, printed by the prior art reservation system to data and electronically saving the data.

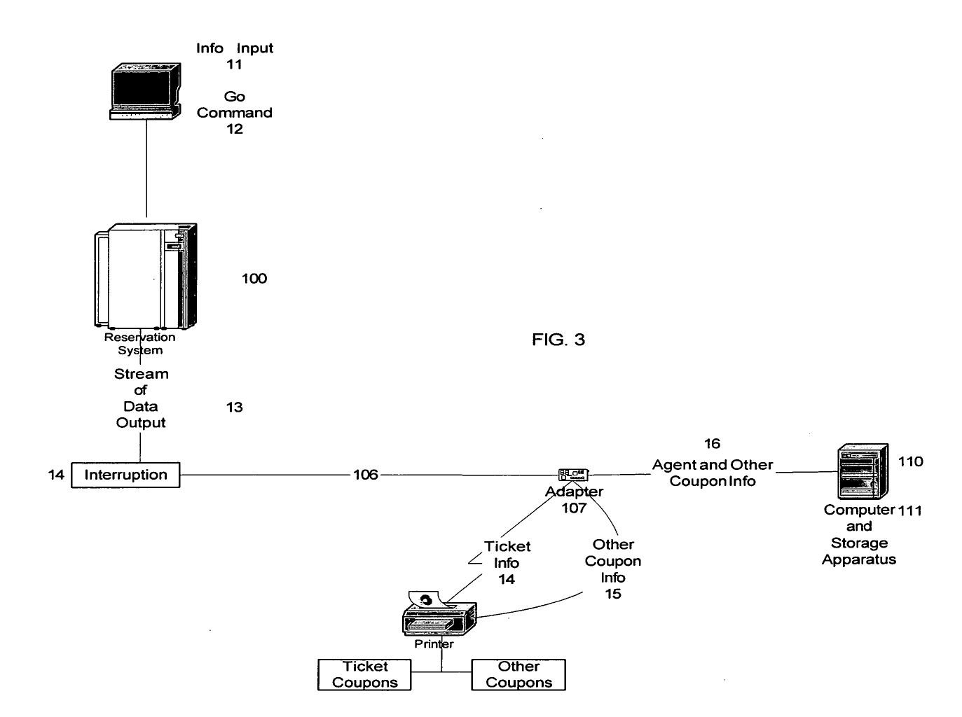

FIG. 3 illustrates, in a simplified manner, the unique method of the present invention that accomplishes the task of creating, capturing and electronically storing the coupon data while simultaneously printing the airline ticket. The reservation information is input 11 to the reservation system 100. Upon issuing the go command 12, or other such instruction telling the system 100 to execute the normal prior art functions associated with the system 100, the system begins to operate in a normal manner. However, the flow of information is interrupted at the output cable of the reservation system. The output cable 106 is instead connected to an adapter 107. The adapter 107 functions to allow the ticket information 14 to be returned to the system 100 printer 105 which then prints only the airline ticket 108 on blank airline ticket stock. It is to be understood that, if desired, the adapter 107 can be arranged to return other coupon information 15 to the printer 104 and print other coupons 109.

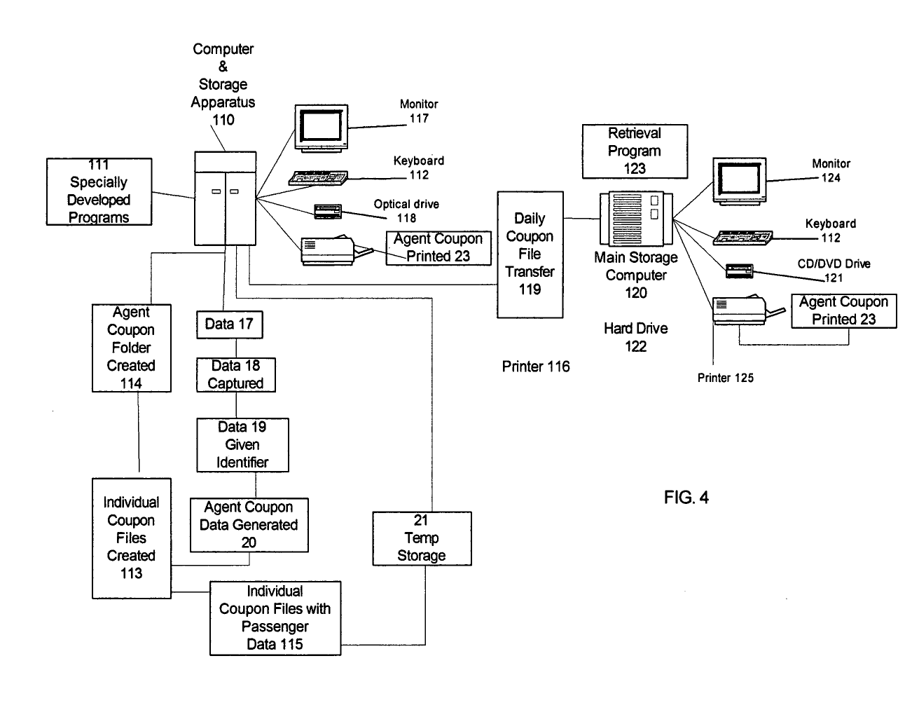

All of the remaining information 16, which includes as a minimum the agent coupon information, is sent through the adapter 107 to the electronic computing and storage apparatus 110 of the present invention. The adapter can comprise a 25 pin to 9 pin serial connector The electronic storage apparatus can include a computer function or an external computer can be operationally connected to the storage apparatus 110. Referring now to FIG. 4, it is seen that a specially designed program 111 is installed in the electronic storage apparatus 110. A keyboard 112 is also connected to the storage apparatus 110. The program 111 works in conjunction with the information 16 input to the storage apparatus 110 and provides first for recognizing or identifying the information associated with an agent coupon, then capturing of the information as raw data associated with each coupon, extracting the extraneous information and instructions from the raw data leaving only the pure agent coupon data, assigning an electronic identifier to each piece of extracted data and then sends the electronically identified information into a coupon data file for each passenger. The program 111 does all of these tasks automatically and thus is not in fact a single program but a number of different programs configured to produce the described functions in the described order. For example, assume that the adapter 107 allows only the raw agent coupon information to be sent to the electronic storage apparatus 110. Referring still to FIG. 4 the program 111 recognizes 17 and then captures 18 the raw information associated with an agent coupon. The raw data is freed of all extraneous information and instructions and or the actual agent coupon data is extracted from the raw data. An electronic identifier is assigned 19 to each piece of actual data, each identifier being unique or particular to each piece of actual data. The particular identifier is one of a number of identifiers that are used only for agent coupons. The program 111 recognizes the identifiers and enters the actual data associated with each identifier into a file 113 that has been previously created 114 within the storage apparatus 110 and labeled for example as an agent coupon file. The format of the agent coupon file 113 is immaterial provided that each electronic identifier enters the particular information associated with it in the agent coupon file 113 as a data item within the previously set up format 114 of the agent coupon file. Of course, common sense and organization would dictate that a convenient and logical format be used. A different agent coupon file 113 is created for each passenger 115; however, the set of agent coupon identifiers 19 are common to each agent coupon data file. Thus, the identifiers 19 remain the same but the information associated with each identifier 19 differs for each passenger. However, all agent coupon files 113 within the storage apparatus are arranged in the same format. At this point, the information previously associated with an agent coupon has been identified, captured as raw data, the raw data being freed of extraneous information and instructions, given an identifier and then entered in an agent coupon file 115 for a particular passenger and is temporarily stored 21 in the storage apparatus 110. In this manner, the agent coupon information has been reformatted as data and can be used electronically in any manner that is common knowledge today. For example, the data can be displayed by known display apparatus 117; can be printed 23 by a printer 116 can be stored on a CD 118 (using the storage apparatus 110); and can be temporarily stored 21 within the storage apparatus 110. However, routinely or as common procedure, the agent coupon data is just temporarily stored 21 in the electronic storage apparatus 110.

The information output by the reservation system 100 can comprise all of the information entered onto an airline ticket, including but not limited, to the information normally associated with an agent coupon as well as any other information deemed appropriate. Upon interrupting the flow of information 14 from the reservation system 100 and being processed by the storage apparatus 110, the newly generated data 20 is formatted and stored in a subfile 115 of an agent coupon folder 113, each subfiles 115 being for a single each passenger. Each subfile 115 is preferably stored 21 in storage apparatus 110 for one business day. Then, at the end of the business day, all of the agent coupon subfiles 115 can be transferred from the storage system 110 to one or more external storage apparatus 120. External storage apparatus 120 can include a hard drive having a storage memory from as little as one to as many as thousands of gigabytes. One external storage apparatus 120 can be located at the travel agency and one or more at any desired remote locations such as a taxing authority facility or an airlines facility. Although not preferred, each subfile 115 can be transmitted from the storage apparatus 110 on an individual basis and or at the time or approximate time that the ticket transaction is being processed or has been completed. The agent coupon data is preferably stored in the main storage facility 120 in a directory under the identifying designation as provided for by the software 123. The identifier designation can further include the passenger's name, and/or the passenger record number, and/or the sales period ending date, any one or all of which can be used to store the agent coupon data in a primary directory and sub-directories. For example, four separate primary directories can exist corresponding to the above identifiers, with each primary directory having three separate sub-directories comprising the other identifiers, all of which are automatically created by the software 123. Or, a single primary directory can be used that is indexed by the passenger's record number. In this manner, any one or all of the identifiers can be used to subsequently retrieve the coupon data.

On a continual or on a nightly basis, the data files 115 stored in storage apparatus 110 and or the data files 119 stored in the main storage facility 120 can be transferred to files named, for example, “DATE tgz”. The “tgz” files can be written to a Random Operating Memory (ROM) compact disk (CD) 2. It is preferred at this time, to record the sales period ending date and the issue date for which this data belongs, into a reference file for future lookup and or retrieval purposes. A software program 121 incorporated in the storage apparatus 120 continuously checks and verifies the available space on the CD 121, and when the CD 121 is full, a message is sent advising an operator to change to a new CD 121. Each CD 121 can have a header file identifier for identification purposes. Alternatively, the data can be simultaneously stored on both a hard disk 122 and a CD 121.

When a dispute, refund, exchange occurs, or it is desirous for any legitimate reason to access the stored data 115, the same can be retrieved as follows. The operator activates a retrieval software program 123 that is loaded into the storage apparatus 120 and inputs information which allows for the retrieval of a particular coupon data, including but not limited to, for example, the agency code number (ARC number), sales period ending date, the ticket number, the record locator and the passenger's name. The storage apparatus 120 searches its hard drive 122 for the file. If the file is not available, because of a system crash or because the file has been purged from the computer, an operator is directed to load the appropriate CD 121 containing the desired data. Upon retrieval of the desired data, a display screen 124 associated with the storage apparatus 120 displays a document, see FIG. 2, which is consistent with the prior art coupon or simply displays the data 115 in any other appropriate format. It is then a simple matter for the operator to command the storage apparatus 120 to print 23 the coupon 115 being retrieved. In this regard, an appropriate printer 125, is electronically connected to the storage apparatus 120. The printed document can be on plain paper in the coupon format, or can be printed on actual ARC approved ticket coupon stock, or can be printed in any appropriate data format

Simultaneously with the operation of the ticketing or ticket reservation arm 104, the reservation system 100 includes a financial arm 105 that creates and retains a file containing all the travel and financial information, FIG. 1. The financial file generation is part of the prior art reservation system 100 which is typically transferred to a computer within the ravel agency such that the travel agency can track the financial information associated with each airline ticket. Although the financial arm 105 information stream comprises all of the information sent to the ticketing arm 104, the financial arm 105 is only concerned with the financial aspects of the reservation file as it relates to each transaction. Thus, the data contained and retained in the financial arm comprises only financial data and various miscellaneous data that allows a bookkeeper to locate and access a particular portion of the financial data. However, because all of the transaction information is present within the financial arm 105, the inventive methods and apparatus can be used to recognize, capture the raw coupon data, extract the actual coupon data, and store the same in a coupon file in the apparatus and in the manner above described.

The present inventive methods and apparatus can also be applied to the prior art system 100 independent of the ticketing arm 104 or the financial arm 105. In this embodiment, the “adapter” being the program 111 that functions to recognize, capture the raw coupon data, extract the actual coupon data, and store the same in a coupon file in the apparatus and in the manner above described.

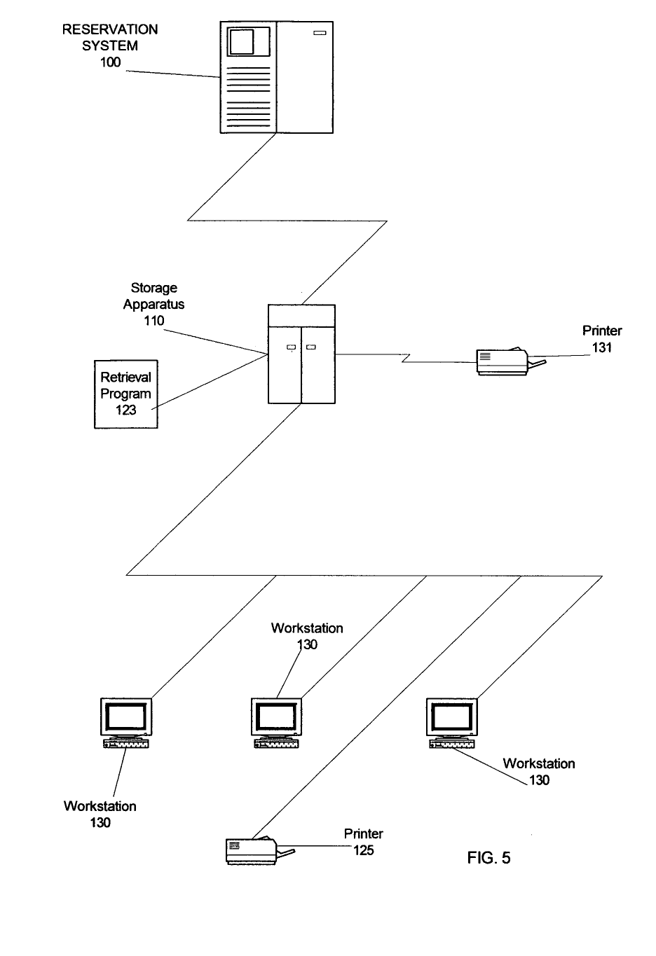

FIG. 5 illustrates the apparatus and methods of FIGS. 3 and 4 as applied to a networked retrieval arrangement. In FIG. 5, a central storage computer 110 is used as the storage apparatus. As in the previous embodiments, the central storage computer 110 is arranged to receive ticket information from a reservation system 100 through an electronic data connection. A plurality of computer equipped workstations 130 are network connected to the central storage computer 110. A central coupon data printer 131 is connected to the central storage computer 110. One or more additional coupon printers 125 can be connected to the networked stations 130 in an appropriate manner consistent with the physical location and arrangement of the workstations 130.

In order to retrieve a particular agent coupon's data, the available identifier or identifiers are input to a retrieval screen brought up by an appropriate instruction to the software. The software 123 then searches its data banks or directories and displays the directory or identifies the CD containing the identifier. If more than one identifier is input, the software again brings up the directory or identifies the CD containing the identifiers. An operator can then select the appropriate identifier which then brings up the coupon data from the hard drive of the storage apparatus 110, or the operator loads the identified CD which then brings up the data. Alternatively, once the identifier or identifiers are input, the software 123 searches the internal or external data banks and directories and directly brings up the coupon data associated with the same. The operator then prints the coupon data onto a paper copy.

The described invention therefore provides methods, software and apparatus to electronically store agent coupon information and/or other data which is generated when an airline ticket is prepared or when a batch data file is received, and then retrieve the coupon data at a later date and print a document which contains all of the coupon data and/or information. In the embodiments, above described, the initiation and activation of the retrieval method can be accomplished on or off the site of the storage apparatus, by for example the use of an internet/intranet connection using an appropriate internet browser and/or Adobe Acrobat Reader. It is to be understood that the indexing and directories, above described, can be varied without departing from the scope of the present invention.

In operation, the inventive methods and apparatus functions as follows. Either by phone, in person, or other electronic transmission, a passenger contacts an airline travel agency for purposes of obtaining a flight reservation and airline ticket. The passenger provides the general information to the travel agent who then inputs the same 11 into a reservation system 100 which of course in general comprises a specialized computer and a printer. The standard reservation system 100 converts the input information into a stream of information that can be read and operated on or processed by the reservation system 100. The processed information is output by the reservation system in the form of an airline ticket or a modern day e-ticket as well as other coupons such as flight coupon(s), passenger receipt, charge coupon, auditor coupon but not an agent coupon. In the preferred embodiment, only the agent coupon information 16 is identified, captured, freed of extraneous information and instructions, and not sent to the printer 104 of the reservation system 100; but rather, is electronically stored as actual coupon data. In other embodiments, other reservation information 16 is identified and captured and not sent to the printer 104 of the reservation system 100 and is also electronically stored. The identifying and capturing can be accomplished either internally within the reservation system 100 or externally after it leaves the reservation system by means of an adapter 107, in either event the captured information is not sent to the printer. In the meantime, the uncaptured ticket information 114 is sent to the printer and subsequently printed 115.

Regardless of the manner that the desired information is identified and captured, it is sent to a computer provided by the present invention which can also be called the electronic storage apparatus 110, or any other arbitrary name. The inventive computer 110 can be located in the confines of the travel agency or virtually anywhere else in the world. Modern day electronic transfer of data allows such different locations of the computer 110 associated with the inventive method. Thus, the agent coupon information contained within the intermingled stream of information is sent to the inventive computer and storage apparatus 110 and is electronically stored as actual data making it possible for retrieval at a later date or on a sporatic basis.

While the invention has been described, disclosed, illustrated and shown in certain terms or certain embodiments or modifications which it has assumed in practice, the scope of the invention is not intended to be nor should it be deemed to be limited thereby and such other modifications or embodiments as may be suggested by the teachings herein are particularly reserved especially as they fall within the breath and scope of the drawings and description provided herein.

What is claimed is:

1. A method for processing airline ticket reservation information for passengers comprising the steps of:
inputting passenger flight information into an airline reservation system that outputs the information in ASCII form,
identifying the information corresponding to an airline ticket,
identifying the information corresponding to all other information including agent coupon information,
allowing the ticket information to be printed transmitting said all other information to electronic apparatus having computing and storage capabilities,
capturing all of the information associated with an the agent coupon and storing the same in a raw data capture file,
extracting the agent coupon data free of all other instructions and extraneous information from the captured raw data file and applying an electronic identifier to the same, and
using the electronic identifier, storing the agent coupon data in an agent coupon folder.

2. The method of claim 1 including the steps of applying an electronic identifier to each piece of information associated with the agent coupon, each identifier being particular for each piece of information and using each particular electronic identifier to locate each piece of information in the data format of the agent coupon file.

3. The method of claim 2 including the step of creating a separate agent coupon data file for each passenger and storing each separate agent coupon file in said agent coupon folder.

4. The method of claim 3 including the step of transmitting said agent coupon files in a batch format to said electronic apparatus and storing each passenger file separately in said electronic storage apparatus.

5. The method of claim 4 including the step of adding a file name to each passenger agent coupon file to allow subsequent searching and retrieval of an individual passenger agent coupon file and displaying the same as a data document.

6. The method of claim 1 including the step of interrupting the flow of information in ASCII form, allowing the ticket information to be returned to the reservation system to be printed and allowing the agent coupon information to be passed on for further processing.

7. The method of claim 6 including the step of adding an adapter to the interrupted flow of information from the reservation system, said adapter being configured to be connected to an outlet connector of a printer cable and to be connected to an inlet connector of said electronic apparatus, whereby the information output from the reservation system, other than the ticket information, is transmitted to and accepted by said electronic apparatus.

8. The method of claim 6 including the step of interrupting the flow of information from the reservation function of the reservation system.

9. The method of claim 6 including the step of interrupting the flow of information from the accounting function of the reservation system.

10. The method of claim 6 including the step of interrupting the flow of information within the reservation system and before it is output as the reservation information or as accounting information.

11. The method of claim 10 including the steps of printing the airline ticket, identifying the agent coupon information, capturing the agent coupon information as raw data, extracting the actual agent coupon data free of any extraneous information associated with said raw data, and electronically storing said actual agent coupon data.

12. The method of claim 11 including the steps of transmitting, in a batch file arrangement and on a periodic basis, a plurality of individual agent coupon data files to said electronic apparatus having storage and computing capabilities.

13. A method for processing airline ticket reservation information for passengers comprising the steps of:
inputting passenger flight information into an airline reservation system that outputs the information in ASCII form,
identifying the information corresponding to an airline ticket,
identifying the information corresponding to all other information including agent coupon information,
allowing the ticket information to be printed
transmitting said all other information to electronic apparatus having computing and storage capabilities,
capturing all of the information associated with an the agent coupon and storing the same in a raw data capture file,
extracting the agent coupon data free of all other instructions and extraneous information from the captured raw data file and applying an electronic identifier to the same,
using the electronic identifier, storing the agent coupon data in an agent coupon file, and
using an internet browser to retrieve said electronically stored agent coupon file, display the agent coupon file in a document format, printing the displayed agent coupon in a document format, and
electronically transmitting the agent coupon file in said document format using an internet browser.

14. Apparatus to be connected to an airlines reservation system comprising in combination, electronic storage and computing apparatus,
an adapter connected at an inlet end to an outlet end of a printer cable that is connected at an inlet end to said airlines reservation system, an outlet end of said adapter being connected to an inlet connector of said electronic storage and computing apparatus,
whereby said adapter transmits any information from said reservation system through said printer cable to said electronic storage and computing apparatus.

15. The apparatus of claim 14 including software installed on said electronic storage and computing apparatus comprising agent coupon information identifying software, agent coupon raw data capturing software, actual agent coupon data extracting software, and software for electronically storing actual agent coupon in individual files in said electronic storage and computing apparatus.

16. The apparatus of claim 15 including a second electronic storage and computing apparatus, and software for transmitting a plurality of individual agent coupon files, in a batch format, to said second electronic storage and computing apparatus.

17. The apparatus of claim 16 including searching, retrieval, displaying and printing software installed on at least one of said electronic storage and computing apparatus.

18. The apparatus of claim 17 including display and printing apparatus connected to at least one of said electronic storage and computing apparatus.

19. Airline ticketing and storage apparatus comprising, in combination airline reservation apparatus,
electronic data storage apparatus,
web sever apparatus including
a computer including at least one processor, RAM memory, a hard drive, compact disk read and write apparatus, DVD apparatus, display apparatus, and a printer, said computer being connected to said airline reservation apparatus,
software means installed in said computer for capturing, generating and transmitting agent coupon data, and for storing, retrieving, and displaying said agent coupon data on memory storage apparatus connected to said computer, and
web server software installed in said computer for retrieving and displaying said stored agent coupon data using an internet browser.
